(19) United States
(12) Patent Application Publication
(10) Pub. No.: US 2025/0311013 A1
(43) Pub. Date: Oct. 2, 2025

(54) INFORMATION TRANSMISSION METHOD AND COMMUNICATION APPARATUS

(71) Applicant: HUAWEI TECHNOLOGIES CO., LTD., Shenzhen (CN)

(72) Inventors: Chuili KONG, Hangzhou (CN); Hejia LUO, Ottawa (CA); Yunfei QIAO, Hangzhou (CN); Yu WANG, Hangzhou (CN); Jianwei ZHOU, Hangzhou (CN)

(21) Appl. No.: 19/237,445

(22) Filed: Jun. 13, 2025

Related U.S. Application Data
(63) Continuation of application No. PCT/CN2023/138949, filed on Dec. 14, 2023.

(30) Foreign Application Priority Data
Dec. 15, 2022 (CN) 202211624137.5

(51) Int. Cl. H04W 74/0833; H04W 56/00

(52) U.S. Cl. CPC H04W 74/0833; H04W 56/0015

(57) ABSTRACT

This application provides an information transmission method and a communication apparatus. The method includes: A terminal receives first indication information from a network device, where the first indication information indicates a first access threshold corresponding to a first synchronization signal; and the terminal determines, based on a value relationship between a local access value and the first access threshold, whether to send random access request information on a random access channel occasion corresponding to the first synchronization signal. This can improve resource utilization.

### CROSS-REFERENCE TO RELATED APPLICATIONS

This application is a continuation of International Application No. PCT/CN2023/138949, filed on Dec. 14, 2023, which claims priority to Chinese Patent Application No. 202211624137.5, filed on Dec. 15, 2022. The disclosures of the aforementioned applications are hereby incorporated by reference in their entireties.

### TECHNICAL FIELD

This application relates to the communication field, and more specifically, to an information transmission method and a communication apparatus.

### BACKGROUND

Compared with a terrestrial mobile communication network, a non-terrestrial network (non-terrestrial network, NTN) is characterized by wide coverage, a wide frequency band, and low costs. Currently, research on integrated satellite-terrestrial communication has been started.

As an access network device, a satellite is quite different from a terrestrial access network device. For example, a signal coverage range of the satellite is far greater than a signal coverage range of a terrestrial base station. Different from the terrestrial base station, the satellite has serious unbalanced communication load in the signal coverage range. For example, a coverage range of one satellite may include both an urban living area with heavy communication load and an area with light load, for example, an ocean and a forest. Because the satellite access network device is different from the terrestrial access network device in characteristics, if a communication mechanism designed for a terrestrial mobile communication system is applied to the NTN, communication efficiency is low.

### SUMMARY

Embodiments of this application provide an information transmission method and a communication apparatus, to improve a success rate of accessing a network by a terminal and resource utilization.

According to a first aspect, an information transmission method is provided. The method may be performed by a terminal or a module (for example, a chip) configured for (or used in) a terminal. The following uses an example in which the terminal performs the method for description.

The method includes: receiving first indication information from a network device, where the first indication information indicates a first access threshold corresponding to a first synchronization signal; and determining, based on a value relationship between a local access value and the first access threshold, whether to send random access request information on a random access channel occasion corresponding to the first synchronization signal.

According to the foregoing solutions, the network device may notify the terminal of an access threshold corresponding to a synchronization signal, so that the terminal determines, by comparing values of a local access value and the access threshold, whether to perform a random access procedure. In this way, the network device can control a quantity of terminals that request to access a network, to control a probability that random access preambles sent by the terminals collide, and improve a success rate of accessing the network by the terminal and resource utilization.

With reference to the first aspect, in some implementations of the first aspect, receiving the first indication information from the network device includes: receiving first information from the network device, where the first information is used to configure the random access channel occasion corresponding to the first synchronization signal, and the first information includes the first indication information.

For example, the first information may be broadcast information, for example, an MIB or an SIB.

With reference to the first aspect, in some implementations of the first aspect, the local access value is a value randomly selected from sample space.

For example, the sample space obeys uniform distribution or normal distribution.

According to the foregoing solutions, the terminal may randomly select a value from the sample space, to randomize a probability of performing the random access procedure by the terminal.

With reference to the first aspect, in some implementations of the first aspect, if the local access value is greater than or equal to the first access threshold, it is determined to send the random access request information on the random access channel occasion corresponding to the first synchronization signal; or if the local access value is less than the first access threshold, it is determined not to send the random access request information to the network device on the random access channel occasion corresponding to the first synchronization signal.

With reference to the first aspect, in some implementations of the first aspect, if the local access value is less than or equal to the first access threshold, it is determined to send the random access request information on the random access channel occasion corresponding to the first synchronization signal; or if the local access value is greater than the first access threshold, it is determined not to send the random access request information to the network device on the random access channel occasion corresponding to the first synchronization signal.

With reference to the first aspect, in some implementations of the first aspect, when it is determined to send the random access request information on the random access channel occasion corresponding to the first synchronization signal, the random access request information is sent to the network device on the random access channel occasion corresponding to the first synchronization signal.

With reference to the first aspect, in some implementations of the first aspect, the method further includes: when it is determined not to send random access request information to the network device on the random access channel occasion corresponding to the first synchronization signal, receiving second indication information from the network device, where the second indication information indicates a second access threshold corresponding to a second synchronization signal, and the second access threshold is used by the terminal to determine whether to perform random access. The second synchronization signal and the first synchronization signal are different synchronization signals in a synchronization signal set in a same synchronization signal periodicity, or the second synchronization signal and the first synchronization signal are synchronization signals in different synchronization signal periodicities.

According to a second aspect, an information transmission method is provided. The method may be performed by a network device or a module (for example, a chip) configured for (or used in) a network device. The following uses the network device as an example.

The method includes: determining first indication information, where the first indication information indicates a first access threshold corresponding to a first synchronization signal, and the first access threshold is used by a terminal to determine whether to perform a random access procedure; and sending the first indication information.

With reference to the second aspect, in some implementations of the second aspect, the sending the first indication information includes: sending first information, where the first information is configuration information of the random access channel occasion corresponding to the first synchronization signal, and the first information includes the first indication information.

With reference to the second aspect, in some implementations of the second aspect, the method further includes: determining the first access threshold based on a quantity of terminals within a coverage range of the first synchronization signal and a quantity of random access channel occasions corresponding to the first synchronization signal.

With reference to the second aspect, in some implementations of the second aspect, the method further includes: obtaining the quantity of terminals through inference based on sensing data and/or historical data, where the sensing data includes the quantity of terminals that are in the coverage range of the first synchronization signal and that are obtained through sensing signal detection, and the historical data includes a quantity of historical terminals in the coverage range of the first synchronization signal.

According to a third aspect, an information transmission method is provided. The method may be performed by a terminal or a module (for example, a chip) configured for (or used in) a terminal. The following uses an example in which the terminal performs the method for description.

The method includes: receiving first information from a network device, where the first information is used to configure a random access channel occasion corresponding to a first synchronization signal, the first information includes information about a quantity of random access channel occasions corresponding to a plurality of synchronization signals, the plurality of synchronization signals include the first synchronization signal, and the plurality of synchronization signals belong to a synchronization signal set in one synchronization signal periodicity; and determining, based on the quantity information, the random access channel occasion corresponding to the first synchronization signal.

According to the foregoing solutions, the network device can configure different synchronization signals corresponding to different quantities of ROs. This can reduce a resource waste and improve resource utilization.

With reference to the third aspect, in some implementations of the third aspect, the first information further includes time-frequency resource configuration information of a random access channel occasion corresponding to the synchronization signal set. Determining, based on the quantity information, the random access channel occasion corresponding to the first synchronization signal includes: determining, based on the time-frequency resource configuration information and the quantity information, the random access channel occasion corresponding to the first synchronization signal.

According to a fourth aspect, an information transmission method is provided. The method may be performed by a network device or a module (for example, a chip) configured for (or used in) a network device. The following uses the network device as an example.

The method includes: determining first information, where the first information is used to configure a random access channel occasion corresponding to a first synchronization signal, the first information includes information about a quantity of random access channel occasions corresponding to a plurality of synchronization signals, the plurality of synchronization signals include the first synchronization signal, the plurality of synchronization signals belong to a synchronization signal set in one synchronization signal periodicity, and the quantity information is used to determine a resource location of the random access channel occasion corresponding to the first synchronization signal; and sending the first information.

With reference to the fourth aspect, in some implementations of the fourth aspect, the first information further includes third indication information, the third indication information indicates a first quantity, the first quantity is a quantity of candidate random access request signals that correspond to the first synchronization signal and that are used to perform a contention-based random access procedure. In addition, the method further includes: sending second information, where the second information is used to configure a random access channel occasion corresponding to a second synchronization signal in the synchronization signal set, the second information includes fourth indication information, the fourth indication information indicates a second quantity, and the second quantity is a quantity of candidate random access request signals that correspond to the second synchronization signal and that are used to perform a contention-based random access procedure. A coverage range of the first synchronization signal is adjacent to a coverage range of a neighboring cell of a cell to which the synchronization signal set belongs, a coverage range of the second synchronization signal is not adjacent to the coverage range of the neighboring cell, and the first quantity is less than the second quantity.

With reference to the fourth aspect, in some implementations of the fourth aspect, a quantity of candidate random access request signals that correspond to the first synchronization signal and that are used to perform a non-contention-based random access procedure is a third quantity, a quantity of candidate random access request signals that correspond to the second synchronization signal and that are used to perform a non-contention-based random access procedure is a fourth quantity, and the third quantity is greater than the fourth quantity.

With reference to the third aspect or the fourth aspect, in some implementations of the third aspect or the fourth aspect, index values of random access channel occasions corresponding to synchronization signals in the synchronization signal set successively increase in ascending or descending order of index values of the corresponding synchronization signals, and the plurality of synchronization signals are synchronization signals with consecutive index values in the synchronization signal set.

With reference to the third aspect or the fourth aspect, in some implementations of the third aspect or the fourth aspect, the plurality of synchronization signals include a synchronization signal whose index value is smallest in the synchronization signal set, and the first synchronization signal is a synchronization signal whose index value is largest in the plurality of synchronization signals. Alternatively, the plurality of synchronization signals include a synchronization signal whose index value is largest in the synchronization signal set, and the first synchronization signal is a synchronization signal whose index value is smallest in the plurality of synchronization signals.

With reference to the third aspect or the fourth aspect, in some implementations of the third aspect or the fourth aspect, the first information further includes time-frequency resource configuration information of a random access channel occasion corresponding to the synchronization signal set.

According to a fifth aspect, an information transmission method is provided. The method may be performed by a terminal or a module (for example, a chip) configured for (or used in) a terminal. The following uses an example in which the terminal performs the method for description.

The method includes: receiving first information, where the first information is used to configure at least one random access channel occasion corresponding to a first synchronization signal; and determining a resource location of the at least one random access channel occasion based on the first information. The first information includes a largest index value and a smallest index value in an index value of the at least one random access channel occasion; or the first information includes a largest index value or a smallest index value in an index value of the at least one random access channel occasion, and further includes a quantity of random access channel occasions in the at least one random access channel occasion.

According to the foregoing solutions, the network device can configure different quantities of ROs for different coverage areas. This can reduce a resource waste and improve resource utilization.

According to a sixth aspect, an information transmission method is provided. The method may be performed by a network device or a module (for example, a chip) configured for (or used in) a network device. The following uses the network device as an example.

The method includes: determining first information, where the first information is used to configure at least one random access channel occasion corresponding to a first synchronization signal; and sending the first information. The first information includes a largest index value and a smallest index value in an index value of the at least one random access channel occasion; or the first information includes a largest index value or a smallest index value in an index value of the at least one random access channel occasion, and further includes a quantity of random access channel occasions in the at least one random access channel occasion.

With reference to the sixth aspect, in some implementations of the sixth aspect, the first information further includes third indication information, the third indication information indicates a first quantity, and the first quantity is a quantity of candidate random access request signals that correspond to the first synchronization signal and that are used to perform a contention-based random access procedure. In addition, the method further includes: sending second information, where the second information is used to configure a random access channel occasion corresponding to a second synchronization signal, the first synchronization signal and the second synchronization signal belong to a synchronization signal set in a same synchronization signal periodicity, the second information includes fourth indication information, the fourth indication information indicates a second quantity, and the second quantity is a quantity of candidate random access request signals that correspond to the second synchronization signal and that are used to perform a contention-based random access procedure. A coverage range of the first synchronization signal is adjacent to a coverage range of a neighboring cell of a cell to which the synchronization signal set belongs, a coverage range of the second synchronization signal is not adjacent to the coverage range of the neighboring cell, and the first quantity is less than the second quantity.

With reference to the sixth aspect, in some implementations of the sixth aspect, a quantity of candidate random access request signals that correspond to the first synchronization signal and that are used to perform a non-contention-based random access procedure is a third quantity, a quantity of candidate random access request signals that correspond to the second synchronization signal and that are used to perform a non-contention-based random access procedure is a fourth quantity, and the third quantity is greater than the fourth quantity.

According to a seventh aspect, an information transmission method is provided. The method may be performed by a network device or a module (for example, a chip) configured for (or used in) a network device. The following uses the network device as an example.

The method includes: sending third indication information, where the third indication information indicates a first quantity, and the first quantity is a quantity of candidate random access request signals that correspond to a first synchronization signal and that are used to perform a contention-based random access procedure; and sending fourth indication information, where the fourth indication information indicates a second quantity, and the second quantity is a quantity of candidate random access request signals that correspond to a second synchronization signal and that are used to perform a contention-based random access procedure. The first synchronization signal and the second synchronization signal belong to a synchronization signal set in a same synchronization signal periodicity, a coverage range of the first synchronization signal is adjacent to a coverage range of a neighboring cell of a cell to which the synchronization signal set belongs, and a coverage range of the second synchronization signal is not adjacent to the coverage range of the neighboring cell, and the first quantity is less than the second quantity.

For example, a random access request signal is a random access preamble (preamble), and is used to initiate a random access procedure.

According to the foregoing solutions, a quantity of candidate random access request signals that are of a corresponding contention-based random access procedure and that are configured by the network device for a terminal in an edge coverage area of the cell may be different from a quantity of candidate random access request signals that are of a corresponding contention-based random access procedure and that are configured by the network device for a terminal in a non-edge coverage area of the cell. In this way, a quantity of random access request signals is configured as required based on different coverage area requirements, to improve resource utilization.

With reference to the seventh aspect, in some implementations of the seventh aspect, a quantity of candidate random access request signals that correspond to the first synchronization signal and that are used to perform a non-contention-based random access procedure is a third quantity, a quantity of candidate random access request signals that correspond to the second synchronization signal and that are used to perform a non-contention-based random access procedure is a fourth quantity, and the third quantity is greater than the fourth quantity.

According to an eighth aspect, a communication apparatus is provided. In a design, the apparatus may include a one-to-one corresponding module for performing the method/operation/step/action according to any implementation of the first aspect, the third aspect, or the fifth aspect. The module may be a hardware circuit, or may be software, or may be a hardware circuit in combination with software.

According to a ninth aspect, a communication apparatus is provided. In a design, the apparatus may include a one-to-one corresponding module for performing the method/operation/step/action according to any implementation of the second aspect, the fourth aspect, the sixth aspect, or the seventh aspect. The module may be a hardware circuit, or may be software, or may be implemented by a hardware circuit in combination with software.

According to a tenth aspect, a communication apparatus is provided, including a processor. The processor may implement the method according to any possible implementation of the first aspect, the third aspect, or the fifth aspect. Optionally, the communication apparatus further includes a memory. The processor is coupled to the memory, and may be configured to execute instructions in the memory, to implement the method according to any possible implementation of the first aspect, the third aspect, or the fifth aspect. Optionally, the communication apparatus further includes a communication interface, and the processor is coupled to the communication interface. In embodiments of this application, the communication interface may be a transceiver, a pin, a circuit, a bus, a module, or another type of communication interface. This is not limited.

In an implementation, the communication apparatus is a terminal device. When the communication apparatus is the terminal device, the communication interface may be a transceiver or an input/output interface.

In another implementation, the communication apparatus is a chip configured in the terminal device. When the communication apparatus is the chip configured in the terminal device, the communication interface may be an input/output interface.

Optionally, the transceiver may be a transceiver circuit. Optionally, the input/output interface may be an input/output circuit.

According to an eleventh aspect, a communication apparatus is provided, including a processor. The processor may implement the method according to any possible implementation of the second aspect, the fourth aspect, the sixth aspect, or the seventh aspect. Optionally, the communication apparatus further includes a memory. The processor is coupled to the memory, and may be configured to execute instructions in the memory, to implement the method according to any possible implementation of the second aspect, the fourth aspect, the sixth aspect, or the seventh aspect. Optionally, the communication apparatus further includes a communication interface, and the processor is coupled to the communication interface. In embodiments of this application, the communication interface may be a transceiver, a pin, a circuit, a bus, a module, or another type of communication interface. This is not limited.

In an implementation, the communication apparatus is a network device. When the communication apparatus is the network device, the communication interface may be a transceiver or an input/output interface.

In another implementation, the communication apparatus is a chip configured in a network device. When the communication apparatus is the chip configured in the network device, the communication interface may be an input/output interface.

Optionally, the transceiver may be a transceiver circuit. Optionally, the input/output interface may be an input/output circuit.

According to a twelfth aspect, a processor is provided, including: an input circuit, an output circuit, and a processing circuit. The processing circuit is configured to: receive a signal through the input circuit, and transmit a signal through the output circuit, so that the processor performs the methods according to the first aspect to the seventh aspect and any possible implementation of the first aspect to the seventh aspect.

In a specific implementation process, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the processor and the various circuits are not limited in embodiments of this application.

According to a thirteenth aspect, a computer program product is provided. The computer program product includes a computer program (which may also be referred as to code or an instruction). When the computer program is run, a computer is enabled to perform the methods according to the first aspect to the seventh aspect and any possible implementation of the first aspect to the seventh aspect.

According to a fourteenth aspect, a computer-readable storage medium is provided. The computer-readable storage medium stores a computer program (which may also be referred as to code or an instruction). When the computer program is run on a computer, the computer is enabled to perform the methods according to the first aspect to the seventh aspect and any possible implementation of the first aspect to the seventh aspect.

According to a fifteenth aspect, a communication system is provided, including at least one network device and at least one terminal device.

### BRIEF DESCRIPTION OF DRAWINGS

FIG. 1 is a diagram of an architecture of a communication system according to an embodiment of this application;

FIG. 2 is a diagram of an architecture of an NTN network to which embodiments of this application is applicable;

FIG. 3 is a diagram of another architecture of an NTN network to which embodiments of this application is applicable;

FIG. 4 is a diagram of a probability that a terminal successfully accesses a network according to an embodiment of this application;

FIG. 5 to FIG. 8 are schematic flowcharts of information transmission methods according to embodiments of this application;

FIG. 9 is a diagram of a coverage range of a satellite used as a network device according to an embodiment of this application;

FIG. 10 is a block diagram of an example of a communication apparatus according to an embodiment of this application; and

FIG. 11 is a diagram of a structure of another example of a communication apparatus according to an embodiment of this application.

### DESCRIPTION OF EMBODIMENTS

The following describes technical solutions of this application with reference to accompanying drawings.

In embodiments of this application, “/” may indicate an “or” relationship between associated objects. For example, A/B may indicate A or B. “and/or” may indicate that there are three relationships between associated objects. For example, A and/or B may indicate the following three cases: Only A exists, both A and B exist, and only B exists, where A and B may be singular or plural. For ease of describing the technical solutions in embodiments of this application, terms such as “first” and “second” may be used for differentiation in embodiments of this application. The words such as “first” and “second” do not limit a quantity and an execution sequence, and the words such as “first” and “second” do not limit a definite difference. In embodiments of this application, the word like “example” or “for example” is used to represent an example, evidence, or a description. Any embodiment or design solution described as “example” or “for example” should not be explained as being more preferred or having more advantages than another embodiment or design solution. A word like “example” or “for example” is used to present a related concept in a specific manner for ease of understanding. In embodiments of this application, “at least one (type)” may alternatively be described as “one (type) or more (types)”, and “a plurality of (types)” may be two (types), three (types), four (types), or more (types). This is not limited in embodiments of this application.

The technical solutions in embodiments of this application may be applied to various communication systems, for example, a long term evolution (long term evolution, LTE) system, a 5G system, a new radio (new radio, NR), a non-terrestrial network (non-terrestrial network, NTN), and a future communication system like a 6th generation mobile communication system. This is not limited in this application.

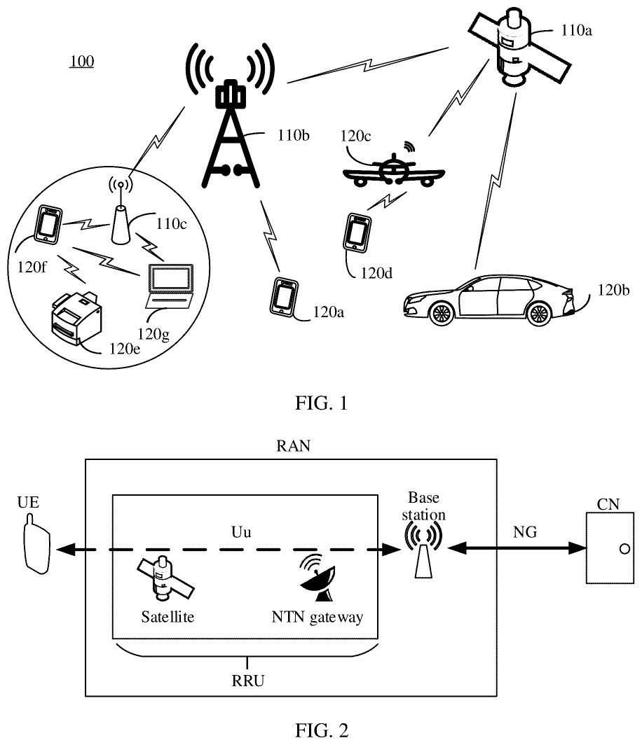

FIG. 1 is a diagram of an architecture of a communication system 100 applicable to an embodiment of this application. As shown in FIG. 1, the communication system 100 may include at least one access network device (for example, 110a, 110b, and 110c in FIG. 1), and may further include at least one terminal (for example, 120a to 120j in FIG. 1). Access network devices may be connected to each other in a wired or wireless manner. FIG. 1 is merely a diagram. The communication system may further include another network device, for example, may further include a wireless relay device and a wireless backhaul device.

In an NTN network, a satellite may implement transparent payload (transparent payload) transmission or regenerative payload (regenerative payload) transmission.

FIG. 2 is a diagram of an architecture of an NTN network to which embodiments of this application are applicable. As shown in FIG. 2, user equipment (user equipment, UE) communicates with a ground base station via a ground base station through a universal terrestrial radio access network-user (universal terrestrial radio access network-user, Uu) interface. A satellite may implement transparent payload transmission between a user and the ground base station. The satellite and an NTN gateway may be considered as a remote radio unit (remote radio unit) of the ground base station, and implement transparent forwarding of a signal. In other words, the satellite supports only functions such as radio frequency filtering and frequency conversion and amplification, where a signal waveform is unchanged. Forwarding of the satellite is transparent to a terminal device. The ground base station may communicate with a core network (core network, CN) through a next generation network (next generation, NG) interface, and exchange, through the NG interface, non-access stratum (non-access stratum, NAS) signaling of the core network and service data of the UE.

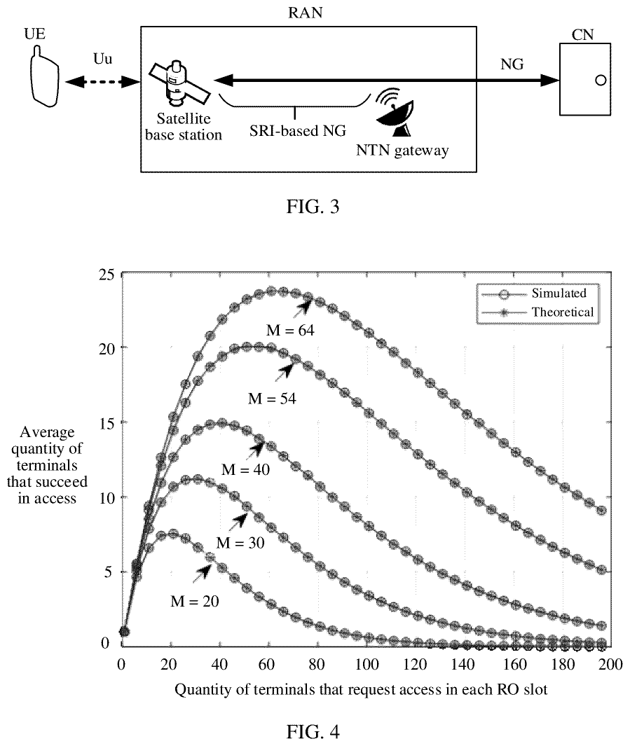

FIG. 3 is a diagram of another architecture of the NTN network to which embodiments of this application are applicable. As shown in FIG. 3, a satellite has some or all functions of an access network device, can be referred to as a satellite base station, and can provide wireless access service and schedule wireless resources for a terminal device that accesses a network through the satellite base station. The satellite base station communicates with UE through a Uu interface. The satellite base station may communicate with a CN through an NG interface, and the satellite base station and the core network may exchange, through the NG interface, NAS signaling and service data of the UE. A satellite radio interface (satellite radio interface, SRI) is a feeder link between an NTN gateway and the satellite. In FIG. 3, the SRI interface may be used as a part of the NG interface to implement communication and interaction between the satellite and the core network.

A network device provided in embodiments of this application may be an access network device, for example, a base station (base station), a NodeB (NodeB), an evolved NodeB (evolved NodeB, eNodeB, or eNB), a transmission reception point (transmission reception point, TRP), a next generation NodeB (next generation NodeB, gNB) in a 5th generation (5th generation, 5G) mobile communication system, an access network device in an open radio access network (open radio access network, O-RAN, or open RAN), a next generation base station in a 6th generation (6th generation, 6G) mobile communication system, a base station in a future mobile communication system, or an access node in a wireless fidelity (wireless fidelity, Wi-Fi) system. Alternatively, the network device may be a module or a unit that completes some functions of the base station, for example, may be a central unit (central unit, CU), a distributed unit (distributed unit, DU), a central unit control plane (CU control plane, CU-CP) module, or a central unit user plane (CU user plane, CU-UP) module. The network device may be a satellite (for example, 110a in FIG. 1 or the satellite base station in FIG. 2), or may be a macro base station (for example, 110b in FIG. 1). Alternatively, the access network device may be a micro base station or an indoor base station (for example, 110c in FIG. 1), or may be a relay node or a donor node. A specific technology and a specific device form that are used by the access network device are not limited in this application.

In embodiments of this application, some or all functions of the network device may be on a non-terrestrial network (non-terrestrial network, NTN) platform (where the NTN platform includes but is not limited to a satellite, an unmanned aircraft system (unmanned aircraft system, UAS), a high altitude communication platform (high altitude platform station, HAPS), and the like), or some or all functions of the network device are on the ground, and the NTN platform is responsible for forwarding a signal between the UE and the access network device.

The terminal device provided in embodiments of this application may also be referred to as a terminal, and includes but is not limited to user equipment (user equipment, UE), a mobile station, a mobile terminal, or the like. The terminal device may be widely used in various scenarios for communication. For example, the scenario includes but is not limited to at least one of the following scenarios: enhanced mobile broadband (enhanced mobile broadband, eMBB), ultra-reliable low-latency communication (ultra-reliable low-latency communication, URLLC), massive machine-type communications (massive machine-type communications, mMTC), device-to-device (device-to-device, D2D) communication, vehicle to everything (vehicle to everything, V2X) communication, machine-type communication (machine-type communication, MTC), an internet of things (internet of things, IOT), virtual reality, augmented reality, industrial control, self-driving, telemedicine, a smart grid, smart furniture, smart office, smart wearable, smart transportation, a smart city, or the like. The terminal device may be a mobile phone (for example, mobile phones 120a, 120d, and 120f in FIG. 1), a tablet computer, a computer (for example, a computer 120g in FIG. 1) having a wireless transceiver function, a wearable device, a vehicle (for example, 120b in FIG. 1), an unmanned aerial vehicle, a helicopter, an airplane (for example, 120c in FIG. 1), a ship, a robot, a mechanical arm, a smart home device (for example, a printer 120e in FIG. 1), or the like. A specific technology and a specific device form used by the terminal device are not limited in this application.

The access network device and/or the terminal device may be fixed or mobile. The access network device and/or the terminal device may be deployed on land, including indoor, outdoor, handheld, or vehicle-mounted, may be deployed on water, or may be deployed on a plane, a balloon, and a satellite in air. Environments/scenarios in which the access network device and the terminal device are located are not limited in this application. The access network device and the terminal device may be deployed in a same environment/scenario or different environments/scenarios. For example, both the access network device and the terminal device may be deployed on the land, or the access network device is deployed on the land, the terminal device is deployed on the water, and the like. Examples are not listed one by one.

In a mobile communication system, a terminal and a network device may establish a communication connection by using a random access procedure. The network device broadcasts configuration information of a physical random access channel (physical random access channel, PRACH) of a cell by using a system message of the cell. The configuration information includes a PRACH configuration index value, for example, a prachConfigurationIndex parameter. The terminal may determine a time domain location of a PRACH resource of the cell based on the index value and a predefined random access configuration table. Specifically, the random access configuration table is retrieved by using the index value, to obtain a subframe number (subframe number) of the PRACH resource corresponding to the index value, a starting symbol (starting symbol) sequence number, and a quantity of PRACH slots included in one subframe that are in the configuration table, a quantity of PRACH occasions (PRACH occasions, ROs) included in one PRACH slot, and PRACH duration, so that the terminal can determine a time domain location of an RO in the PRACH resource of the cell. In addition, the configuration information of the random access channel further includes frequency domain start location information (for example, an msg1-FrequencyStart parameter) of the PRACH resource and a quantity of ROs in frequency domain multiplexing (for example, an msg1-FDM parameter), so that the terminal may determine a frequency domain location of the RO in the PRACH resource, to obtain a time-frequency location of the RO in the PRACH resource of the cell and a quantity of ROs. The RO is a resource used to transmit a random access preamble (preamble).

The network device may provide communication services for terminals in different areas in the cell by using a plurality of beams, and index values of synchronization signal blocks (also called, synchronization signal and physical broadcast channel block, SSB) sent by the network device by using the plurality of beams are different. For example, after receiving an SSB n sent by the network device, the terminal may determine, based on a correspondence that is between an SSB and an RO and that is configured based on an index value of the SSB n and the configuration information of the PRACH, an RO corresponding to the SSB n, and send random access request information, for example, a random access preamble, on the RO. Correspondingly, if the network device receives the random access preamble from the terminal on the RO corresponding to the SSB n, the network device may determine that the terminal is in a coverage range of a beam for sending the SSB n, and the network device may send the random access response information to the terminal by using the beam.

Currently, the configuration information of the PRACH notifies the terminal of the correspondence between an SSB and an RO by indicating a quantity of SSBs corresponding to one RO. An optional value range of the quantity of SSBs corresponding to one RO is {⅛, ¼, ½, 1, 2, 4, 8, 16}, where ⅛ indicates that one SSB corresponds to eight ROs, and ¼ indicates that one SSB corresponds to four ROs. By analogy, 16 indicates that 16 SSBs correspond to one RO. The terminal determines, based on a value in the optional value range indicated by the configuration information of the PRACH, the quantity of SSBs corresponding to one RO, to determine an RO corresponding to each SSB.

For example, the configuration information of the PRACH indicates that the PRACH configuration index value is 27, and the quantity of ROs in frequency domain multiplexing is 2. The terminal may determine time-frequency locations of the ROs. For example, the PRACH resource lasts for 20 slots, and each slot includes two ROs in frequency domain. In addition, the configuration information of the PRACH indicates ¼, that is, one SSB corresponds to four ROs. In this case, the terminal may determine a correspondence between eight SSBs in an SSB set of the network device and ROs, as shown in Table 1. Each SSB corresponds to four ROs. For example, an SSB 0 corresponds to an RO 0 to an RO 3, and an SSB 1 corresponds to an RO 4 to an RO 7. By analogy, an SSB 7 corresponds to an RO 28 to an RO 31, where an RO 33 to an RO 38 are not used.

TABLE 1

| | | | | | | | | | | | | | | | | | | | | |
|---|---|---|---|---|---|---|---|---|---|---|---|---|---|---|---|---|---|---|---|---|
| Slot | 0 | 1 | 2 | 3 | 4 | 5 | 6 | 7 | 8 | 9 | 0 | 1 | 2 | 3 | 4 | 5 | 6 | 7 | 8 | 9 |
| sequence | | | | | | | | | | | | | | | | | | | | |
| number | | | | | | | | | | | | | | | | | | | | |
| RO | 1 | 3 | 5 | 7 | 9 | 11 | 13 | 15 | 17 | 19 | 21 | 23 | 25 | 27 | 29 | 31 | 33 | 35 | 37 | 39 |
| sequence | 0 | 2 | 4 | 6 | 8 | 10 | 12 | 14 | 16 | 18 | 20 | 22 | 24 | 26 | 28 | 30 | 32 | 34 | 36 | 38 |
| number | | | | | | | | | | | | | | | | | | | | |

| | | | | | | | | | |
|---|---|---|---|---|---|---|---|---|---|
| SSB 0 | SSB 1 | SSB 2 | SSB 3 | SSB 4 | SSB 5 | SSB 6 | SSB 7 | Not | Not |

| | |
|---|---|
| used | used |

The terminal may determine, based on an index value of a detected SSB, four ROs corresponding to the SSB. The terminal may select one RO from the four ROs for sending a random access preamble.

The configuration information of the PRACH may further indicate a quantity of contention-based (contention-based, CB) random access preambles corresponding to each SSB. An optional value range of the quantity of random access preambles is {4, 8, 12, 16, 20, 24, 28, 32, 36, 40, 44, 48, 52, 56, 60, 64}. The terminal may randomly select a random access preamble from random access preambles corresponding to the detected SSB, and send the random access preamble to the network device on the RO corresponding to the SSB, to initiate a random access procedure.

It is found in practice that, when a quantity of random access preambles configured on one RO is fixed, there is a non-linear relationship between a quantity of terminals that request to access a network and a quantity of terminals that successfully access the network. As shown in FIG. 4, M indicates a quantity of random access preambles configured on one RO. When a value of M is fixed, when the quantity of terminals that request to access the network is small, the quantity of terminals that successfully access the network increases with an increase of the quantity of terminals that request to access the network, and a probability that a terminal successfully accesses the network is high. However, as the quantity of terminals that request to access the network further increases, a probability that a terminal successfully accesses the network gradually decreases. A main reason is that when the quantity of terminals that request to access the network is large, a probability that preambles sent by different terminals collide increases, and a large quantity of terminals cannot access the network because the preambles sent by the terminals collide. In this way, a probability that a terminal successfully accesses the network is reduced.

For the foregoing problem, embodiments of this application propose that the network device sends an access threshold, and the terminal determines, after comparing values of a local access value and the access threshold, whether to perform a random access procedure. In this manner, the quantity of terminals that request to access the network can be controlled, to control a probability that random access preambles sent by the terminals collide, and improve a success rate and efficiency of accessing the network by the terminal.

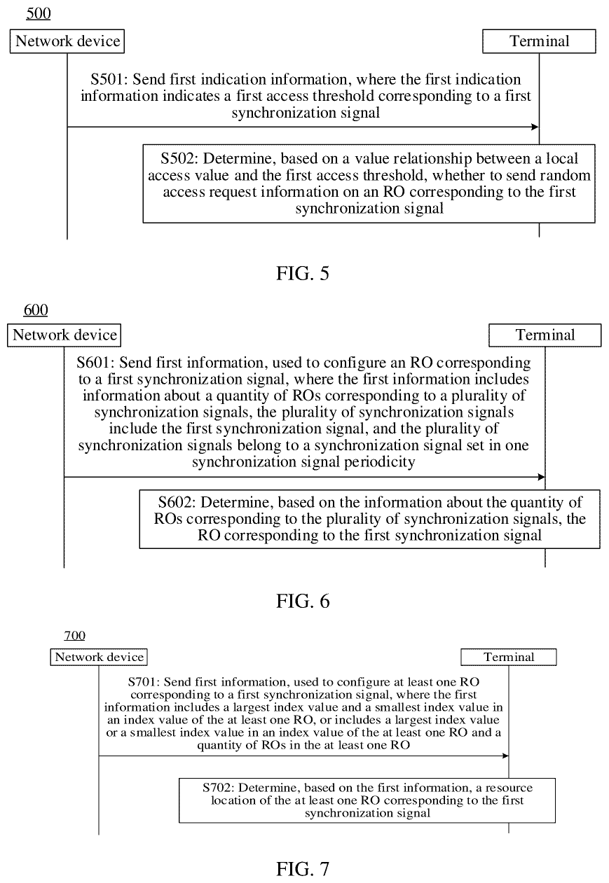

FIG. 5 is a schematic flowchart of an information transmission method 500 according to an embodiment of this application.

S501: A network device sends first indication information, where the first indication information indicates a first access threshold corresponding to a first synchronization signal.

The first access threshold is used by a terminal to determine whether to perform a random access procedure.

The network device sends at least one synchronization signal, where the at least one synchronization signal includes the first synchronization signal, and one of the at least one synchronization signal is sent by the network device by using one beam, that is, one beam corresponding to one synchronization signal. For example, the network device sends the first synchronization signal by using a first beam, and the first access threshold may also be referred to as an access threshold corresponding to the first beam. This is not limited in this application.

For example, a synchronization signal may be a synchronization signal in a synchronization signal block SSB in a mobile communication system, and the first access threshold is an access threshold corresponding to a first SSB, or an access threshold corresponding to the first beam for sending a first SSB.

The terminal receives the first indication information from the network device, and determines, based on the first indication information, the first access threshold corresponding to the first synchronization signal. For example, the terminal performs synchronization signal detection, and detects the first synchronization signal, that is, the terminal is in a coverage range of a beam used by the network device to send the first synchronization signal. The terminal may perform time-frequency synchronization with the network device based on the first synchronization signal, and then determine the first access threshold based on the first indication information received from the network device, to determine, based on the first access threshold, whether the random access procedure, for example, sending random access request information, can be initiated on an RO corresponding to the first synchronization signal.

In an implementation, the first indication information may be carried in broadcast information sent by the network device to the terminal. For example, the broadcast information may be a master information block (master information block, MIB) or a system information block (system information block, SIB).

For example, that a network device sends first indication information includes: The network device sends first information, where the first information is used to configure the RO corresponding to the first synchronization signal, and the first information includes the first indication information.

For example, the first information is an SIB 1, the first synchronization signal is a synchronization signal in an SSB, the SIB 1 is configured with an RO corresponding to the first SSB, and the SIB 1 further includes the first indication information. After receiving the SIB 1, the terminal may determine the RO corresponding to the first SSB and the first access threshold, and compare a local access value with the first access threshold, to determine whether the random access request information can be sent on the RO corresponding to the first SSB to initiate the random access procedure.

For example, the SIB 1 includes RACH common configuration information (which may be denoted as RACH-ConfigCommon), and the RACH common configuration information includes RACH generic configuration information (which may be denoted as rach-ConfigGeneric). The generic configuration information is used to configure a time domain location and a frequency domain location of an RO in a cell. For example, rach-ConfigGeneric includes the prachConfigurationIndex parameter and the msg1-FDM parameter described above. In addition, the RACH common configuration information further includes configuration information of an RO and a contention-based (contention-based, CB) preamble that correspond to the SSB (which may be denoted as an ssb-perRACH-OccasionAndCB-PreamblesPerSSB) and the first indication information (which may be denoted as AccessThreshold). For example, the RACH common configuration information may be expressed as follows:

RACH-ConfigCommon ::= SEQUENCE {

| | |
|---|---|
| rach-ConfigGeneric | RACH-ConfigGeneric, |

...
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1...16), |
| eight | INTEGER (1...8), |
| sixteen | INTEGER (1...4) |
| AccessThreshold | ENUMERATED{dot1,dot2,dot3,dot4,dot5,dot6,dot7,dot8,dot9,1} |

}
...}

Here, ssb-perRACH-OccasionAndCB-PreamblesPerSSB is a parameter of a choice (CHOICE) type, and one of the eight available options shown below is selected during configuration. For example, “oneEighth” indicates that one SSB corresponds to eight ROs, or “oneEighth” indicates that one SSB is mapped to eight ROs or indicates that one SSB corresponds to eight ROs, “oneFourth” indicates that one SSB corresponds to four ROs, “oneHalf” indicates that one SSB corresponds to two ROs, “one” indicates that one RO corresponds to one SSB, and so on. The “ENUMERATED” part indicates a quantity of contention-based preambles corresponding to one SSB, and one value is enumerated from the subsequent curly brace, where n4 indicates that one SSB corresponds to four contention-based preambles, n8 indicates that one SSB corresponds to eight contention-based preambles, and so on. The contention-based preamble is a preamble used by the terminal to initiate a contention-based random access procedure.

A value range of the first access threshold may be a value greater than 0 and less than or equal to 1. For example, the first access threshold is a value in {0.1, 0.2, 0.3, 0.4, 0.5, 0.6, 0.7, 0.8, 0.9, 1}. For example, the foregoing AccessThreshold, used as the first indication information, is an enumerated (ENUMERATED) parameter, and one value can be enumerated from the value range, where dot1 indicates 0.1, dot2 indicates 0.2, and so on. In the foregoing example, an example in which precision of the first access threshold is one decimal place is used for description. However, this application is not limited thereto. In specific implementation, a value and the precision of the first access threshold may be set based on a requirement. For example, the precision of the first access threshold may alternatively be two or three decimal places.

It should be noted that the foregoing merely provides, as an example, the configuration information used to configure the RO and the preamble and the first indication information that are included in the RACH common configuration information. The RACH common configuration information may further include other information that is not shown above. This is not limited in this application.

In an implementation, the network device determines the first access threshold based on a quantity of terminals within a coverage range of the first synchronization signal and a quantity of ROs corresponding to the first synchronization signal.

For example, the network device may obtain, through inference based on sensing data and/or historical data, the quantity of terminals within the coverage range of the first synchronization signal. The sensing data includes a quantity of terminals within the coverage range of the first synchronization signal that is obtained through sensing signal detection, and the historical data includes a historical quantity of terminals within the coverage range of the first synchronization signal.

For example, the network device may infer, by using an artificial intelligence (artificial intelligence, AI) technology, the quantity of terminals within the coverage range of the first synchronization signal by using an intelligent model. For example, the network device may input the sensing data and/or the historical data into the intelligent model, to obtain a current quantity of terminals within the coverage range of the first synchronization signal that is output by the intelligent model through inference. The network device determines the first access threshold based on the quantity of terminals and the quantity of ROs corresponding to the first synchronization signal. For example, the network device may determine, based on simulated and theoretical results shown in FIG. 4, the first access threshold corresponding to the first synchronization signal, to control, by controlling a quantity of terminals that request to access the network, a probability that random access request information sent by the terminals collides, and improves a success probability and efficiency of accessing the network by the terminal.

In an example, a larger quantity of active terminals within the coverage range of the first synchronization signal indicates a higher probability that the random access request information sent by the terminals collides, and indicates a smaller value of the first access threshold determined by the network device. When the local access value is less than or equal to the first access threshold, the terminal may send the random access request information on the RO corresponding to the first synchronization signal. When the local access value is greater than the first access threshold, the terminal does not send the random access request information on the RO corresponding to the first synchronization signal. However, when the probability that the random access request information sent by the terminals collides is low, the network device may configure a maximum value of the first access threshold. For example, if the value range of the first access threshold is greater than 0 and less than or equal to 1, the maximum value is 1. The local access value of the terminal is less than the maximum value, and the terminal may send the random access request information on the RO corresponding to the first synchronization signal as required.

For example, when a satellite is used as the network device, the satellite covers different areas by using a plurality of beams, and different beams in the plurality of beams send synchronization signals with different index values. For example, for a city commercial area covered by a synchronization signal 1, the network device can obtain, through inference, that a quantity of active terminals is large, and for a marine area covered by a synchronization signal 2, the network device can obtain, through inference, that a quantity of active terminals is small. Therefore, an access threshold A that is determined by the network device and that corresponds to the synchronization signal 1 is less than an access threshold B corresponding to the synchronization signal 2. For example, the access threshold A is 0.4. After obtaining the access threshold A, the terminal located in a coverage range of the synchronization signal 1 compares the local access value with the access threshold A. When the local access value is less than or equal to 0.4, for example, the local access value of the terminal is 0.1 (as described below, the local access value of the terminal may be preconfigured or randomly generated), the terminal may send random access request information on an RO corresponding to the synchronization signal 1, to initiate a random access procedure. When the local access value is greater than 0.4, for example, if the local access value of the terminal is 0.5, the terminal does not send the random access request information on the RO corresponding to the synchronization signal 1. The network device may control, based on the access threshold A, a quantity of terminals that request to access a network, to control a probability that random access request information sent by the terminals collides, and improve a success rate and efficiency of accessing the network by the terminal. However, because there are a small quantity of active terminals within a coverage range of the synchronization signal 2, the access threshold B may be 1, namely, the maximum value of the access threshold. The network device does not limit a random access procedure initiated by a terminal in the coverage range of the synchronization signal 2. The terminal in the coverage range of the synchronization signal 2 may send random access request information on an RO corresponding to the synchronization signal 2, to initiate the random access procedure.

In another example, a larger quantity of active terminals within the coverage range of the first synchronization signal indicates a higher probability that the random access request information sent by the terminals collides, and indicates a larger value of the first access threshold determined by the network device. When the local access value is greater than or equal to the first access threshold, the terminal may send the random access request information on the RO corresponding to the first synchronization signal. When the local access value is less than the first access threshold, the terminal does not send the random access request information on the RO corresponding to the first synchronization signal. However, when the probability that the random access request information sent by the terminals collides is low, the network device may configure a minimum value of the first access threshold. For example, if the value range of the first access threshold is greater than or equal to 0 and less than 1, the minimum value is 0. The local access value of the terminal is greater than the minimum value, and the terminal may send the random access request information on the RO corresponding to the first synchronization signal as required.

S502: The terminal determines, based on a value relationship between the local access value and the first access threshold, whether to send the random access request information on the RO corresponding to the first synchronization signal.

The local access value of the terminal may be preconfigured in the terminal, or the local access value may be a value randomly selected by the terminal from sample space. For example, the sample space may be sample space that meets uniform distribution or normal distribution.

For example, the sample space includes a value from 0 to 1, the terminal randomly selects a value from the sample space as the local access value, and the terminal obtain the value relationship between the local access value and the first access threshold through comparison, to determine whether to send the random access request information on the RO corresponding to the first synchronization signal.

In an implementation, if the local access value is greater than or equal to the first access threshold, it is determined to send the random access request information on the RO corresponding to the first synchronization signal. If the local access value is less than the first access threshold, it is determined not to send the random access request information on the RO corresponding to the first synchronization signal.

In another implementation, if the local access value is less than or equal to the first access threshold, it is determined to send the random access request information on the RO corresponding to the first synchronization signal. If the local access value is greater than the first access threshold, it is determined not to send the random access request information on the RO corresponding to the first synchronization signal.

If the terminal determines, based on the value relationship between the local access value and the first access threshold, to send the random access request information on the RO corresponding to the first synchronization signal, the terminal sends the random access request information on the RO corresponding to the first synchronization signal. For example, the random access request information is a preamble (preamble) that is used for random access and that corresponds to the first synchronization signal.

If the terminal determines, based on the value relationship between the local access value and the first access threshold, not to send the random access request information on the RO corresponding to the first synchronization signal, the terminal may receive second indication information from the network device. The second indication information indicates a second access threshold corresponding to a second synchronization signal, and the second access threshold is used by the terminal to determine whether to perform a random access procedure. The second synchronization signal and the first synchronization signal are different synchronization signals in a synchronization signal set in a same synchronization signal periodicity, or the second synchronization signal and the first synchronization signal are synchronization signals in different synchronization signal periodicities.

For example, the terminal determines, based on the local access value and the first access threshold, not to send the random access request information on the RO corresponding to the first synchronization signal. The terminal may continue to detect a synchronization signal, and the terminal may detect the second synchronization signal that belongs to the synchronization signal set in the same synchronization signal periodicity as the first synchronization signal. The synchronization signal set includes synchronization signals sent by the network device by using different beams. In this case, the terminal receives the second indication information, determines the second access threshold corresponding to the second synchronization signal, and determines, by comparing a value relationship between a local access value and the second access threshold, whether to send random access request information on an RO corresponding to the second synchronization signal.

For another example, the terminal determines, based on the local access value and the first access threshold, not to send the random access request information on the RO corresponding to the first synchronization signal. The terminal may continue to detect a synchronization signal, and the terminal may detect the second synchronization signal in a periodicity after a synchronization signal periodicity to which the first synchronization signal belongs. The second synchronization signal may be a synchronization signal whose index value is the same as an index value of the first synchronization signal. In other words, the second synchronization signal and the first synchronization signal belong to different periodicities, but are synchronization signals sent by using a same beam of the network device. The terminal receives the second indication information, determines the second access threshold corresponding to the second synchronization signal, and determines, by comparing a value relationship between a local access value and the second access threshold, whether to send random access request information on an RO corresponding to the second synchronization signal.

The local access value used by the terminal for comparison with the second access threshold may be the local access value used for comparison with the first access threshold. For example, it may be specified that a same local access value is used for comparison with access thresholds corresponding to synchronization signals in a same synchronization signal periodicity or synchronization signals with a same identifier in different synchronization signal periodicities. Alternatively, the local access value used by the terminal for comparison with the second access threshold may not be the local access value used for comparison with the first access threshold. For example, it may be specified that the terminal randomly selects a local access value in the sample space each time the terminal detects a synchronization signal. However, this application is not limited thereto.

According to the foregoing solutions, the network device may notify the terminal of an access threshold corresponding to a synchronization signal, so that the terminal determines, by comparing values of a local access value and the access threshold, whether to perform a random access procedure. In this way, the network device can control the quantity of terminals that request to access the network, to reduce a probability that random access preambles sent by the terminals collide, and improve a success rate and efficiency of accessing the network by the terminal.

As described above, in a currently used PRACH configuration manner, quantities of ROs corresponding to a plurality of SSBs are uniform. In other words, quantities of ROs that can be used by the terminal in beam coverage areas corresponding to different SSBs are the same. However, when the satellite is used as an access network device, communication load imbalance in a signal coverage range of the satellite is severe. In this manner of uniform mapping between SSBs and ROs, problems of low RO utilization and a severe resource waste may occur in a low communication load area in which a small quantity of terminal devices request to access a network. Alternatively, in an area with heavy communication load, a quantity of terminal devices that request to access a network is large, and a plurality of terminals may collide due to limited ROs. Consequently, random access efficiency is low. According to the PRACH configuration manner provided in this embodiment of this application, different quantities of ROs can be configured for different coverage areas, so that a resource waste can be reduced, and resource utilization can be increased.

FIG. 6 is a schematic flowchart of an information transmission method 600 according to an embodiment of this application. According to the information transmission method 600, a network device may configure a quantity of ROs corresponding to a plurality of synchronization signals in a same synchronization signal periodicity, so that a terminal can determine an RO of a first synchronization signal in the plurality of synchronization signals. Different quantities of ROs can be configured for different coverage areas. The method includes but is not limited to the following steps.

S601: The network device sends first information, where the first information is used to configure a random access occasion corresponding to the first synchronization signal, the first information includes information about the quantity of ROs corresponding to the plurality of synchronization signals, the plurality of synchronization signals include the first synchronization signal, and the plurality of synchronization signals belong to a synchronization signal set in one synchronization signal periodicity.

For example, the first information may be broadcast information, for example, an MIB or an SIB.

In a synchronization signal set in a same synchronization signal periodicity, index values of ROs corresponding to synchronization signals may successively increase in ascending or descending order of index values of the corresponding synchronization signals, and the plurality of synchronization signals are synchronization signals with consecutive index values in the synchronization signal set.

The index values of the ROs are sequentially arranged based on the index values of the corresponding synchronization signals. In this case, the network device may provide a quantity of ROs corresponding to synchronization signals whose index values are less than an index value of the first synchronization signal, or provide a quantity of ROs corresponding to synchronization signals whose index values are greater than an index value of the first synchronization signal, so that the terminal can determine a location of the RO corresponding to the first synchronization signal.

In an implementation, the plurality of synchronization signals include a synchronization signal whose index value is smallest in the synchronization signal set to which the plurality of synchronization signals belong, and the first synchronization signal is a synchronization signal whose index value is largest in the plurality of synchronization signals.

In other words, the network device provides, for the terminal by using the first information, a quantity of ROs corresponding to the synchronization signal whose index value is smallest to the first synchronization signal. For example, if the smallest index value of the synchronization signal in the synchronization signal set is 0, the first information includes information about a quantity of ROs corresponding to a synchronization signal whose index value is 0 and that is in each index value of the index values of the first synchronization signal.

For example, the network device covers a plurality of areas by using eight beams, and index values of SSBs sent by using the eight beams are different. For example, index values of eight SSBs are respectively 0 to 7. In other words, an SSB set (which may be referred to as an SSB burst set (SSB burst set)) in one SSB periodicity includes eight SSBs, which are respectively an SSB 0 to an SSB 7. The synchronization signals sequentially correspond to the ROs in ascending order of index values. That is, a synchronization signal with a smaller index value corresponds to an RO with a smaller index value, and a synchronization signal with a larger index value corresponds to an RO with a larger index value. A quantity of ROs corresponding to different synchronization signals may vary based on different load situations. The network device determines, based on load statuses in coverage ranges of the eight SSBs, a quantity of ROs corresponding to an SSB sent by each beam. For example, larger load in a coverage range of the SSB indicates a larger quantity of ROs, and smaller load indicates a smaller quantity of ROs. As shown in Table 2, the SSB 0 corresponds to four ROs in total: an RO 0 to an RO 3, the SSB 1 corresponds to eight ROs in total: an RO 4 to an RO 11, the SSB 2 corresponds to an RO 12 and an RO 13, and ROs corresponds the SSB 3 to the SSB 7 may be determined based on Table 2.

TABLE 2

| | | | | | | | | | | | | | | | | | | | | |
|---|---|---|---|---|---|---|---|---|---|---|---|---|---|---|---|---|---|---|---|---|
| Slot | 0 | 1 | 2 | 3 | 4 | 5 | 6 | 7 | 8 | 9 | 0 | 1 | 2 | 3 | 4 | 5 | 6 | 7 | 8 | 9 |
| sequence | | | | | | | | | | | | | | | | | | | | |
| number | | | | | | | | | | | | | | | | | | | | |
| RO | 1 | 3 | 5 | 7 | 9 | 11 | 13 | 15 | 17 | 19 | 21 | 23 | 25 | 27 | 29 | 31 | 33 | 35 | 37 | 39 |
| sequence | 0 | 2 | 4 | 6 | 8 | 10 | 12 | 14 | 16 | 18 | 20 | 22 | 24 | 26 | 28 | 30 | 32 | 34 | 36 | 38 |
| number | | | | | | | | | | | | | | | | | | | | |

| | | | | | | | |
|---|---|---|---|---|---|---|---|
| SSB 0 | SSB 1 | SSB 2 | SSB 3 | SSB 4 | SSB 5 | SSB 6 | SSB 7 |

For example, if the SSB 2 is the first synchronization signal, the first information may include information about a quantity of ROs corresponding to three consecutive SSBs: the synchronization signal with the smallest index value (namely, the SSB 0) to the SSB 2. For example, the first information includes quantity information 0, quantity information 1, and quantity information 2. The quantity information 0 indicates that a quantity of ROs corresponding to the SSB 0 is 4, the quantity information 1 indicates that a quantity of ROs corresponding to the SSB 1 is 8, and the quantity information 2 indicates that a quantity of ROs corresponding to the SSB 2 is 2. In this way, the terminal may determine, based on information about a quantity of a plurality of SSBs in the first information, locations of the ROs corresponding to the SSB 2. The first information includes quantity information corresponding to each of the SSB 0 to the SSB 2, and each piece of quantity information includes a quantity of ROs corresponding to a corresponding SSB. However, this application is not limited thereto. The first information may include a total quantity of ROs corresponding to two SSBs whose index values are less than an index value of the SSB 2 and the quantity of ROs corresponding to the SSB 2. For example, the first information includes the total quantity 12 of ROs corresponding to the SSBs whose index values are less than the index value of the SSB 2 and the quantity 2 of ROs corresponding to the SSB 2. In this case, the terminal may determine that the ROs corresponding to the SSBs whose index values are less than the index value of the SSB 2 are the RO 0 to the RO 11, and the two ROs corresponding to the SSB 2 are the RO 12 and the RO 13. If the terminal determines, based on a local access value and a first access threshold, to send random access request information to the network device on the RO corresponding to the SSB 2, the terminal may select one RO from the RO 12 and the RO 13 for sending the random access request information. For example, the terminal sends a random access request preamble to the network device on the RO 12.

In an example, the first information is an SIB 1, the SIB 1 includes RACH common configuration information (which may be denoted as RACH-ConfigCommon), and the RACH common configuration information includes configuration information of ROs and contention-based preambles that correspond to each of the plurality of SSBs. The configuration information of the ROs and the contention-based preambles that correspond to each SSB indicates a quantity of ROs corresponding to the corresponding SSB. For example, if the first information is used to configure the ROs of the SSB 1, the first information includes configuration information of the ROs and contention-based preambles that correspond to the SSB 0 and the SSB 1. For example, the RACH-ConfigComon may be represented as follows:

| RACH-ConfigComon : : = Sequence { | |
|---|---|
| ... | |
| ssb-perRACH-OccasionAndCB-PreamblesPerSSBforSSB#0 SEQUENCE{ | |
| ssb-sub-perRACH-OccasionAndCB-PreamblesPerSSB CHOICE { | |
| oneEighth | ENUMERATED |
| {n4,n8,n12,n16,n20,n24,n28,n32,n36,n40,n44,n48,n52,n56,n60,n64}, | |
| oneFourth | ENUMERATED |
| {n4,n8,n12,n16,n20,n24,n28,n32,n36,n40,n44,n48,n52,n56,n60,n64}, | |
| oneHalf | ENUMERATED |
| {n4,n8,n12,n16,n20,n24,n28,n32,n36,n40,n44,n48,n52,n56,n60,n64}, | |
| one | ENUMERATED |
| {n4,n8,n12,n16,n20,n24,n28,n32,n36,n40,n44,n48,n52,n56,n60,n64}, | |
| two | ENUMERATED {n4,n8,n12,n16,n20,n24,n28,n32}, |
| four | INTEGER (1...16), |
| eight | INTEGER (1...8), |
| sixteen | INTEGER (1...4) |
| }} | |
| ssb-perRACH-OccasionAndCB-PreamblesPerSSBforSSB#1 SEQUENCE{ | |
| ssb-sub-perRACH-OccasionAndCB-PreamblesPerSSB CHOICE { | |
| oneEighth | ENUMERATED |
| {n4,n8,n12,n16,n20,n24,n28,n32,n36,n40,n44,n48,n52,n56,n60,n64}, | |
| oneFourth | ENUMERATED |
| {n4,n8,n12,n16,n20,n24,n28,n32,n36,n40,n44,n48,n52,n56,n60,n64}, | |
| oneHalf | ENUMERATED |
| {n4,n8,n12,n16,n20,n24,n28,n32,n36,n40,n44,n48,n52,n56,n60,n64}, | |
| one | ENUMERATED |
| {n4,n8,n12,n16,n20,n24,n28,n32,n36,n40,n44,n48,n52,n56,n60, n64}, | |
| two | ENUMERATED {n4,n8,n12,n16,n20,n24,n28,n32}, |
| four | INTEGER (1...16), |
| eight | INTEGER (1...8), |
| sixteen | INTEGER (1...4) |

```
      }}
      ...}
```

As shown above, ssb-perRACH-OccasionAndCB-PreamblesPerSSBforSSB #0 is configuration information of the ROs and preambles that correspond to the SSB 0. For the configuration information, one of the following parameters may be selected by using ssb-sub-perRACH-OccasionAndCB-PreamblesPerSSB. For example, the oneFourth parameter is selected to notify the terminal that the quantity of ROs corresponding to the SSB 0 is 4. In addition, ssb-perRACH-OccasionAndCB-PreamblesPerSSBforSSB #1 is configuration information of the ROs and preambles that correspond to the SSB 1. For the configuration information, the following oneEighth parameter is selected by using ssb-sub-perRACH-OccasionAndCB-PreamblesPerSSB, to notify the terminal that the quantity of ROs corresponding to the SSB 1 is 8. In this way, the terminal may determine, based on the first information and a correspondence sequence between corresponding SSBs and ROs, that the SSB 0 corresponds to four ROs in total: the RO 0 to the RO 3. In this case, the eight ROs corresponding to the SSB 1 are the RO 4 to the RO 11. In addition, the RO and the preamble configuration information that are respectively corresponding to the SSB 1 may further notify, by enumerating (ENUMERATED) a value in n4 to n64, the terminal of a quantity of preambles corresponding to the SSB 1.

In another implementation, the plurality of synchronization signals include a synchronization signal whose index value is largest in the synchronization signal set, and the first synchronization signal is a synchronization signal whose index value is smallest in the plurality of synchronization signals.

In other words, the first information includes information about a quantity of ROs corresponding to the first synchronization signal to the synchronization signal with the largest index value. If the first information is used to configure the ROs corresponding to the SSB 2 shown in Table 2, the first information includes quantity information indicating a quantity of ROs corresponding to each of the SSB 2 to the SSB 7, or the first information may include quantity information indicating a quantity of ROs corresponding to the SSB 2 and quantity information indicating a total quantity of ROs corresponding to the SSB 3 to the SSB 7. The terminal may determine, based on the quantity information in the first information, that the total quantity of ROs corresponding to the SSB 3 to the SSB7 is 26. In this case, the SSB 3 to the SSB 7 correspond to the last 26 ROs, namely, the RO 14 to the RO 39. Therefore, the terminal may determine that the two ROs corresponding to the SSB 2 are the RO 12 and the RO 13.

For another example, when the first information is used to configure the ROs corresponding to the SSB 2 shown in Table 2, the first information includes configuration information of ROs and contention-based preambles that correspond to each of the SSB 2 to the SSB 7. The terminal may determine, based on configuration information of the ROs and the contention-based preambles that correspond to each SSB and that are in the first information, a quantity of ROs corresponding to each of the SSB 2 to the SSB7, to determine locations of the ROs corresponding to the SSB 2.

It should be noted that Table 2 is used as an example for description. Table 2 shows a correspondence that an SSB with a smaller index value corresponds to an RO with a smaller index value. However, this application is not limited thereto. In specific implementation, a correspondence between an SSB and an RO may be that an SSB with a smaller index value corresponds to an RO with a larger index value, that is, an SSB with a larger index value corresponds to an RO with a smaller index value.

S602: The terminal determines, based on the information about the quantity ROs corresponding to the plurality of synchronization signals, the RO corresponding to the first synchronization signal.

After receiving the first information in S601, the terminal may determine, based on the quantity information that is in the first information and that is of the ROs corresponding to the plurality of synchronization signals, the RO corresponding to the first synchronization signal.

The first information further includes time-frequency resource configuration information of an RO corresponding to the synchronization signal set to which the plurality of synchronization signals belong. That the terminal determines, based on the quantity information, the RO corresponding to the first synchronization signal includes: The terminal determines, based on the time-frequency resource configuration information and the quantity information, the RO corresponding to the first synchronization signal.

For example, the time-frequency resource configuration information of the RO in the first information includes a prachConfigurationIndex parameter used to determine a time domain location of the RO and an msg1-FDM parameter used to determine a quantity of ROs in frequency domain multiplexing. The terminal may determine, based on the time-frequency resource configuration information of the ROs in the first information, time-frequency locations of the ROs corresponding to the synchronization signal set in the synchronization signal periodicity. The terminal may determine, based on the quantity information that is in the first information and that is of the ROs corresponding to the plurality of synchronization signals, the location of the RO corresponding to the first synchronization signal.

According to the foregoing solutions, the network device can configure different synchronization signals corresponding to different quantities of ROs. This can reduce a resource waste and improve resource utilization.

FIG. 7 is a schematic flowchart of an information transmission method 700 according to an embodiment of this application. According to the information transmission method 700, a network device may configure a location of an RO corresponding to a first synchronization signal, so that a terminal can determine the RO of the first synchronization signal. Different quantities of ROs can be configured for different coverage areas. The method includes but is not limited to the following steps.

S701: The network device sends first information, where the first information is used to configure at least one RO corresponding to the first synchronization signal.

For example, the first information may be broadcast information, for example, an MIB or an SIB.

An indication manner in which the first information indicates the at least one RO may include but is not limited to the following manners.

Manner 1: The first information includes a smallest index value and a largest index value in index values of ROs corresponding to the first synchronization signal.

Manner 2: The first information includes a largest index value or a smallest index value in index values of ROs corresponding to the first synchronization signal and a quantity of ROs corresponding to the first synchronization signal.

S702: The terminal determines, based on the first information, the at least one RO corresponding to the first synchronization signal.

In an example, the first information indicates, in Manner 1, the at least one RO corresponding to the first synchronization signal. The terminal may determine, based on time-frequency resource configuration information of ROs in the first information, time-frequency resource locations of ROs corresponding to a synchronization signal set of a synchronization signal periodicity in which the first synchronization signal is located, and may determine, based on the largest index value and the smallest index value that are of the ROs corresponding to the first synchronization signal and that are included in the first information, a location of the at least one RO corresponding to the first synchronization signal.

For example, if the first information is used to configure the ROs corresponding to the SSB 4 shown in Table 2, the first information may include a smallest index value 20 and a largest index value 25 of the ROs corresponding to the SSB 4, and the terminal may determine, based on the index values 20 and 25 of the ROs, that the ROs corresponding to the SSB 4 are six ROs whose index values are 20 to 25.

In another example, the first information indicates, in Manner 2, the at least one RO corresponding to the first synchronization signal.

For example, the first information includes a smallest index value in an index value of the at least one RO and a quantity of ROs corresponding to the first synchronization signal. If the first information is used to configure the ROs corresponding to the SSB 6 shown in Table 2, the first information includes a smallest index value 28 of the ROs corresponding to the SSB 6 and a quantity 8 of ROs corresponding to the SSB 6. After receiving the first information, the terminal may determine, based on the time-frequency resource configuration information of the ROs in the first information, time-frequency resource locations of RO 0 to RO 39 corresponding to an SSB set to which the SSB6 belongs, determine, based on an index value 28 of an RO in the first information, that the smallest index value of the ROs corresponding to the SSB 6 is 28, and determine, based on the quantity 8 of ROs in the first information, that eight ROs corresponding to the SSB 6 are the RO 28 to the RO 35.

For example, the first information may be an SIB 1 corresponding to the first synchronization signal, the SIB 1 includes RACH common configuration information (which may be denoted as RACH-ConfigCommon), and the RACH common configuration information includes an RO start location parameter (which is denoted as RACH-OccasionStart) and an RO length parameter (which is denoted as RACH-OccassionLength), where the RO start location parameter indicates the smallest index value in the index value of the RO corresponding to the first synchronization signal. The RO length parameter indicates the quantity of ROs corresponding to the first synchronization signal. For example, the RACH-ConfigCommon may be represented as follows:

| RACH-ConfigCommon ::= SEQUENCE { | |
|---|---|
| rach-ConfigGeneric | RACH-ConfigGeneric, |
| ... | |
| RACH-OccasionStart | 28 |
| RACH-OccasionLength | 8 |

}

RACH-OccasionStart indicates that the smallest index value of the RO corresponding to the first synchronization signal is 28, and RACH-OccasionStart indicates that the quantity of ROs corresponding to the first synchronization signal is 8. After receiving the SIB 1 including RACH-ConfigCommon, the terminal may determine that the eight ROs corresponding to the first synchronization signal are the RO 28 to the RO 35. For RACH generic configuration information (which may be denoted as rach-ConfigGeneric) in RACH-ConfigCommon, refer to the foregoing descriptions. Details are not described herein again.

For another example, the first information includes a largest index value in an index value of the RO and a quantity of ROs corresponding to the first synchronization signal. If the first information is used to configure the ROs corresponding to the SSB 6 shown in Table 2, the first information includes a largest index value 35 of the ROs corresponding to the SSB 6 and a quantity 8 of ROs corresponding to the SSB 6. After receiving the first information, the terminal may determine, based on the time-frequency resource configuration information of the ROs in the first information, time-frequency resource locations of the RO 0 to the RO 38 corresponding to an SSB set to which the SSB 6 belongs, determine, based on an index value 35 of an RO in the first information, that the largest index value of the ROs corresponding to the SSB 6 is 35, and determine, based on the quantity 8 of ROs in the first information, that eight ROs corresponding to the SSB 6 are the RO 28 to the RO 35.

According to the foregoing solutions, the network device can configure different quantities of ROs for different coverage areas. This can reduce a resource waste and improve resource utilization.

For example, when a satellite is used as the network device, the satellite covers different areas by using a plurality of beams, and different beams in the plurality of beams send synchronization signals with different index values. For example, for an urban living area covered by a synchronization signal 1, the network device can obtain, through inference, that a quantity of active terminals is large, and for a marine area covered by a synchronization signal 2, the network device can obtain, through inference, that a quantity of active terminals is small. Therefore, the network device determines that a quantity of ROs corresponding to the synchronization signal 1 is greater than a quantity of ROs corresponding to the synchronization signal 2, and notifies, by using the method provided in the embodiment shown in FIG. 6 or FIG. 7, the terminal of an RO corresponding to a synchronization signal. In this way, the network device configures different quantities of ROs based on different load statuses of coverage areas of synchronization signals, so that a resource waste can be reduced, and resource utilization can be improved.

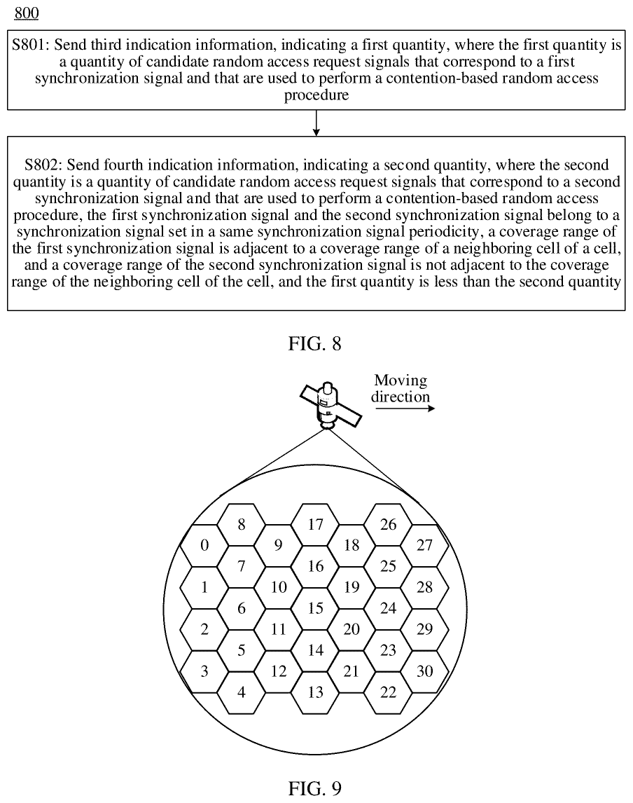

FIG. 8 is a schematic flowchart of an information transmission method 800 according to an embodiment of this application. According to the information transmission method 800, a quantity of candidate random access request signals that are of a corresponding contention-based random access procedure and that are configured by a network device for a terminal in an edge coverage area of a cell may be different from a quantity of candidate random access request signals that are of a corresponding contention-based random access procedure and that are configured by the network device for a terminal in a non-edge coverage area of the cell. The method includes but is not limited to the following steps.

S801: The network device sends third indication information, where the third indication information indicates a first quantity, and the first quantity is a quantity of candidate random access request signals that correspond to a first synchronization signal and that are used to perform a contention-based random access procedure.

The candidate random access request signal used to perform the contention-based random access procedure may be referred to as a contention-based candidate random access request signal. For example, the random access request signal may be a preamble (preamble), and the contention-based candidate random access request signal is a contention-based preamble.

A coverage area of the first synchronization signal is an edge area of a cell, that is, a coverage range of the first synchronization signal is adjacent to a coverage range of a neighboring cell of the cell to which the first synchronization signal belongs.

For example, the third indication information may be carried in first information, and the first information is used to configure an RO corresponding to the first synchronization signal. The first information may be broadcast information, for example, an MIB or an SIB.

For example, the first information may be an SIB 1, the SIB 1 includes configuration information of the RO and the contention-based preamble (for example, the preamble is an example of the random access request signal) that correspond to the first synchronization signal, and the configuration information is used to configure the first quantity of preambles corresponding to the first synchronization signal. For details, refer to the foregoing descriptions. Details are not described herein again.

S802: The network device sends fourth indication information, where the fourth indication information indicates a second quantity, and the second quantity is a quantity of candidate random access request signals that correspond to a second synchronization signal and that are used to perform a contention-based random access procedure. The first synchronization signal and the second synchronization signal belong to a synchronization signal set in a same synchronization signal periodicity, the coverage range of the first synchronization signal is adjacent to a coverage range of a neighboring cell of a cell to which the synchronization signal set belongs, and a coverage range of the second synchronization signal is not adjacent to the coverage range of the neighboring cell of the cell, and the first quantity is less than the second quantity.

In other words, a coverage area of the second synchronization signal is a non-edge area of a cell, that is, the coverage range of the second synchronization signal is not adjacent to a coverage range of a neighboring cell of the cell to which the second synchronization signal belongs.

For example, the fourth indication information may be carried in second information, and the second information is used to configure an RO corresponding to the second synchronization signal. The second information may be broadcast information, for example, an MIB or an SIB. For example, the second information may be an SIB 1 corresponding to the second synchronization signal.

The terminal may initiate an initial random access procedure by using the contention-based candidate random access request signal configured by the network device. The network device may further configure a non-contention-based candidate random access request signal for the terminal. The non-contention-based candidate random access request signal may be used in a terminal handover process. For example, the terminal initiates, based on the non-contention-based random access request signal, a random access procedure in a target cell to which the terminal is handed over.

For example, when a satellite is used as the network device, because the satellite has a large delay and a high moving speed, the satellite may leave an edge area of a current cell in short time, and does not provide a service for a terminal in the area. The terminal may be out of coverage of an original satellite in the initial random access procedure, and usage efficiency of a contention-based candidate random access signal corresponding to a synchronization signal (for example, the first synchronization signal) that covers the edge area of the cell may be low. Therefore, the network device may configure fewer contention-based random access signals for the synchronization signal covering the edge area of the cell than a synchronization signal covering a non-edge area of the cell, to improve resource utilization.

In an implementation, a quantity of candidate random access request signals that correspond to the first synchronization signal and that are used to perform a non-contention-based random access procedure is a third quantity, a quantity of candidate random access request signals that correspond to the second synchronization signal and that are used to perform a non-contention-based random access procedure is a fourth quantity, and the third quantity is greater than the fourth quantity.

For example, when the satellite is used as the network device, a terminal located in the edge area of the cell may need to perform cell handover due to movement of the satellite and/or movement of the terminal, and the terminal has a high requirement for performing the random access procedure by using the non-contention-based candidate random access request signal. However, a handover requirement of a terminal in the non-edge area of the cell is extremely low. Therefore, the network device may configure a quantity (namely, the third quantity) of non-contention-based candidate random access request signals corresponding to the first synchronization signal that covers the edge area of the cell to be greater than a quantity (namely, the fourth quantity) of non-contention-based candidate random access request signals corresponding to the second synchronization signal that covers the non-edge area of the cell. This can reduce a resource waste and improve resource utilization.

For example, as shown in FIG. 9, the satellite is used as the network device, and covers 31 areas by using 31 beams. Numbers of synchronization signals sent by using the 31 beams are sequentially 0 to 31, and are in one-to-one correspondence with area numbers 0 to 31. For example, a synchronization signal 0 covers an area 0, and a synchronization signal 1 covers an area 1. By analogy, a synchronization signal 31 covers an area 31. For example, for non-edge areas 14, 15, and 16 of a cell, a handover requirement of the terminal is extremely low, and an initial access requirement is high. However, for edge areas 0, 1, 2, and 3 of the cell, a handover probability requirement of the terminal is high. However, if the terminal performs the initial access process, the satellite may not cover an area in which the terminal is located in the initial access process. In this way, utilization efficiency of the candidate random access request signal used to perform the contention-based random access procedure is low. Therefore, a quantity of corresponding contention-based candidate random access signals respectively configured by the network device for synchronization signals 14, 15, and 16 that cover the non-edge areas of the cell may be greater than a quantity of corresponding contention-based candidate access signals respectively configured for synchronization signals 0, 1, 2, and 3 that cover the edge areas of the cell, or a quantity of corresponding non-contention-based candidate random access signals respectively configured by the network device for synchronization signals 14, 15, and 16 may be less than a quantity of corresponding non-contention-based candidate access signals respectively configured for synchronization signals 0, 1, 2, and 3.

According to the foregoing solutions, the quantity of candidate random access request signals that are of the corresponding contention-based random access procedure and that are configured by the network device for the terminal in the edge coverage area of the cell may be different from the quantity of candidate random access request signals that are of the corresponding contention-based random access procedure and that are configured by the network device for the terminal in the non-edge coverage area of the cell. In this way, a quantity of random access request signals is configured as required based on different coverage area requirements, to improve resource utilization.

It should be noted that in each embodiment of this application, if there is no special explanation and logical conflict, the terms and/or descriptions between different embodiments are consistent and can be referenced to each other, and the technical features in different embodiments can be combined to form new embodiments according to their inherent logical relations.

It may be understood that, to implement the functions in the foregoing embodiments, the network device and the terminal include corresponding hardware structures and/or software modules for performing each function. A person skilled in the art should be easily aware that, in combination with the units and the method steps in the examples described in embodiments disclosed in this application, this application can be implemented by using hardware or a combination of hardware and computer software. Whether a function is performed by hardware or hardware driven by computer software depends on particular application scenarios and design constraints of the technical solutions.

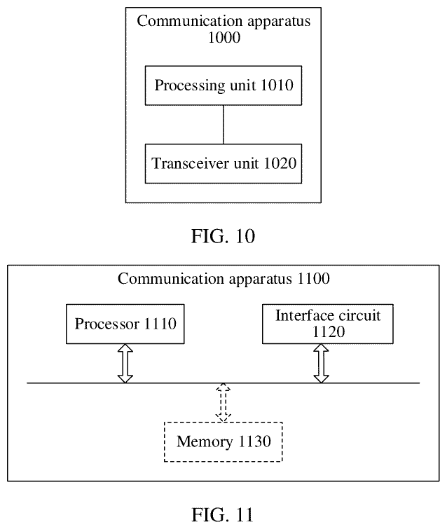

FIG. 10 and FIG. 11 are diagrams of structures of possible communication apparatuses according to embodiments of this application. These communication apparatuses may be configured to implement functions of the terminal or the network device in the foregoing method embodiments, and therefore can also implement beneficial effects of the foregoing method embodiments. In embodiments of this application, the communication apparatus may be one of the terminals 120a to 120j as shown in FIG. 1, or the network device 110a or 110b as shown in FIG. 1, or a module (for example, a chip or a system on chip) used in the terminal or the network device.

The communication apparatus 1000 includes a transceiver unit 1020, and the transceiver unit 1020 may be used to receive or send information. The communication apparatus 1000 may further include a processing unit 1010, and the processing unit 1010 may be used to process instructions or data, to implement corresponding operations.

It should be understood that, when the communication apparatus 1000 is a chip configured in (or used for) a communication device, the transceiver unit 1020 in the communication apparatus 1000 may be an input/output interface or a circuit of the chip, and the processing unit 1010 in the communication apparatus 1000 may be a processor in the chip.

Optionally, the communication apparatus 1000 may further include a storage unit 1030, the storage unit 1030 may be used to store instructions or data, and the processing unit 1010 may execute the instructions or data stored in the storage unit, to enable the communication apparatus to implement corresponding operations.

The communication apparatus 1000 may be configured to implement a function of the network device or the terminal in the method embodiment shown in FIG. 5.

When the communication apparatus 1000 is configured to implement the function of the terminal in the method embodiment shown in FIG. 5, the transceiver unit 1020 is configured to receive first indication information from a network device, where the first indication information indicates a first access threshold corresponding to a first synchronization signal. The processing unit 1010 is configured to determine, based on a value relationship between a local access value and the first access threshold, whether to send random access request information on a random access channel occasion corresponding to the first synchronization signal.

When the communication apparatus 1000 is configured to implement the function of the network device in the method embodiment shown in FIG. 5, the processing unit 1010 is configured to determine first indication information, where the first indication information indicates a first access threshold corresponding to a first synchronization signal, and the first access threshold is used by a terminal to determine whether to perform a random access procedure. The transceiver unit 1020 is configured to send the first indication information.

The communication apparatus 1000 may be configured to implement a function of the network device or the terminal in the method embodiment shown in FIG. 6.

When the communication apparatus 1000 is configured to implement the function of the terminal in the method embodiment shown in FIG. 6, the transceiver unit 1020 is configured to receive first information from a network device, where the first information is used to configure a random access channel occasion corresponding to a first synchronization signal, the first information includes information about a quantity of random access channel occasions corresponding to a plurality of synchronization signals, the plurality of synchronization signals include the first synchronization signal, and the plurality of synchronization signals belong to a synchronization signal set in one synchronization signal periodicity. The processing unit 1010 is configured to determine, based on the quantity information, the random access channel occasion corresponding to the first synchronization signal.

When the communication apparatus 1000 is configured to implement the function of the network device in the method embodiment shown in FIG. 6, the processing unit 1010 is configured to determine first information, where the first information is used to configure a random access channel occasion corresponding to a first synchronization signal, the first information includes information about a quantity of random access channel occasions corresponding to a plurality of synchronization signals, the plurality of synchronization signals include the first synchronization signal, the plurality of synchronization signals belong to a synchronization signal set in one synchronization signal periodicity, and the quantity information is used to determine a resource location of the random access channel occasion corresponding to the first synchronization signal. The transceiver unit 1020 is configured to send the first information.

The communication apparatus 1000 may be configured to implement a function of the network device or the terminal in the method embodiment shown in FIG. 7.

When the communication apparatus 1000 is configured to implement the function of the terminal in the method embodiment shown in FIG. 7, the transceiver unit 1020 is configured to receive first information, where the first information is used to configure at least one random access channel occasion corresponding to a first synchronization signal. The processing unit 1010 is configured to determine a resource location of the at least one random access channel occasion based on the first information. The first information includes a largest index value and a smallest index value in an index value of the at least one random access channel occasion; or the first information includes a largest index value or a smallest index value in an index value of the at least one random access channel occasion, and further includes a quantity of random access channel occasions in the at least one random access channel occasion.

When the communication apparatus 1000 is configured to implement the function of the network device in the method embodiment shown in FIG. 7, the processing unit 1010 is configured to determine first information, where the first information is used to configure at least one random access channel occasion corresponding to a first synchronization signal. The transceiver unit 1020 is configured to send the first information. The first information includes a largest index value and a smallest index value in an index value of the at least one random access channel occasion; or the first information includes a largest index value or a smallest index value in an index value of the at least one random access channel occasion, and further includes a quantity of random access channel occasions in the at least one random access channel occasion.

The communication apparatus 1000 may be configured to implement a function of the network device or the terminal in the method embodiment shown in FIG. 8.

When the communication apparatus 1000 is configured to implement the function of the network device in the method embodiment shown in FIG. 8, the transceiver unit 1020 is configured to send third indication information, where the third indication information indicates a first quantity, and the first quantity is a quantity of candidate random access request signals that correspond to a first synchronization signal and that are used to perform a contention-based random access procedure. The transceiver unit 1020 is further configured to send fourth indication information, where the fourth indication information indicates a second quantity, and the second quantity is a quantity of candidate random access request signals that correspond to a second synchronization signal and that are used to perform a contention-based random access procedure. The first synchronization signal and the second synchronization signal belong to a synchronization signal set in a same synchronization signal periodicity, a coverage range of the first synchronization signal is adjacent to a coverage range of a neighboring cell of a cell to which the synchronization signal set belongs, and a coverage range of the second synchronization signal is not adjacent to the coverage range of the neighboring cell, and the first quantity is less than the second quantity. The processing unit 1010 is configured to control the transceiver unit 1020 to receive or send information.

For more detailed descriptions of the foregoing processing unit 1010 and transceiver unit 1020, refer to related descriptions in the method embodiment shown in FIG. 8.

It should be understood that the transceiver unit 1020 in the communication apparatus 1000 can be implemented through a communication interface (for example, a transceiver, a transceiver circuit, an input/output interface, or a pin). When the communication interface is a transceiver, the transceiver may include a receiver and/or a transmitter. The processing unit 1010 in the communication apparatus 1000 may be implemented by at least one processor. The processing unit 1010 in the communication apparatus 1000 may alternatively be implemented by at least one logic circuit. Optionally, the communication apparatus 1000 further includes a memory unit, and the memory unit may be implemented by a memory.

As shown in FIG. 11, a communication apparatus 1100 includes a processor 1110 and an interface circuit 1120. The processor 1110 and the interface circuit 1120 are coupled to each other. It may be understood that the interface circuit 1120 may be a transceiver or an input/output interface. Optionally, the communication apparatus 1100 may further include a memory 1130, configured to store instructions to be executed by the processor 1110, input data needed by the processor 1110 to run instructions, or data generated after the processor 1110 runs instructions.

In an implementation, the memory 1130 may alternatively be integrated into the processor 1110, or may be independent of the processor 1110.

When the communication apparatus 1100 is configured to implement the method shown in FIG. 8, the processor 1110 is configured to implement the function of the processing unit 1010, and the interface circuit 1120 is configured to implement the function of the transceiver unit 1020.

When the communication apparatus is a chip used in a terminal device, the chip of the terminal device can implement the functions of the terminal in the foregoing method embodiments. The chip in the terminal device receives information from another module (for example, a radio frequency module or an antenna) in the terminal device, where the information is transmitted by the network device to the terminal device. Alternatively, the chip in the terminal device transmits information to another module (for example, a radio frequency module or an antenna) in the terminal device, where the information is transmitted by the terminal device to the network device.

When the communication apparatus is a module used in a network device, the module of the network device can implement the functions of the network device in the foregoing method embodiments. The module in the network device receives information from another module (for example, a radio frequency module or an antenna) in the network device, where the information is sent by a terminal device to the network device. Alternatively, the module in the network device sends information to another module (for example, a radio frequency module or an antenna) in the network device, where the information is sent by the network device to a terminal device. The network device module herein may be a baseband chip of the network device, or may be a DU or another module. The DU herein may be a DU in an open radio access network (open radio access network, O-RAN) architecture.

It may be understood that, the processor in embodiments of this application may be a central processing unit (Central Processing Unit, CPU), or may be another general-purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. The general purpose processor may be a microprocessor or any regular processor or the like.

The method steps in embodiments of this application may be implemented in hardware, or may be implemented in software instructions that may be executed by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk drive, a removable hard disk drive, a CD-ROM, or any other form of storage medium well-known in the art. For example, a storage medium is coupled to a processor, so that the processor can read information from the storage medium and write information into the storage medium. The storage medium may alternatively be a component of the processor. The processor and the storage medium may be disposed in an ASIC. In addition, the ASIC may be located in an access network device or a terminal device. The processor and the storage medium may alternatively exist as discrete components in the access network device or the terminal device.

According to the methods provided in embodiments of this application, an embodiment of this application further provides a computer program product, and the computer program product includes computer program code. When the computer program code is executed by one or more processors, an apparatus including the processor is enabled to perform the methods shown in FIG. 5 to FIG. 8.

All or some of the foregoing embodiments may be implemented by using software, hardware, firmware, or any combination thereof. When software is used to implement embodiments, all or a part of embodiments may be implemented in a form of a computer program product. The computer program product includes one or more computer programs or instructions. When the computer programs or the instructions are loaded and executed on a computer, the procedures or functions in embodiments of this application are completely or partially generated. The computer may be a general-purpose computer, a special-purpose computer, a computer network, a network device, user equipment, or another programmable apparatus.

According to the methods provided in embodiments, an embodiment of this application further provides a computer-readable storage medium, and the computer-readable storage medium stores a computer program or instructions. When the computer program or instructions are run by one or more processors, an apparatus including the processor is enabled to perform the methods shown in FIG. 5 to FIG. 8.

For example, the foregoing computer program or instructions may be stored in the computer-readable storage medium, or may be transmitted from one computer-readable storage medium to another computer-readable storage medium. For example, the computer program or instructions may be transmitted from one website, computer, server, or data center to another website, computer, server, or data center in a wired or wireless manner. The computer-readable storage medium may be any usable medium accessible by a computer, or a data storage device like a server or a data center, integrating one or more usable media. The usable medium may be a magnetic medium, for example, a floppy disk, a hard disk, a magnetic tape, or may be an optical medium, for example, a digital video disk, or may be a semiconductor medium, for example, a solid state drive. The computer-readable storage medium may be a volatile or non-volatile storage medium, or may include two types of storage media: a volatile storage medium and a non-volatile storage medium.

According to the method provided in embodiments of this application, an embodiment of this application further provides a communication system, including one or more network devices described above. The system may further include one or more terminals described above.

In several embodiments provided in this application, it should be understood that the disclosed system, apparatus, and method may be implemented in other manners. For example, the foregoing apparatus is merely an example. For example, division of the foregoing units is only logical function division. In actual implementation, there may be another division manner. For example, a plurality of units or components can be combined or integrated into another system, or some features can be ignored, or not implemented. In addition, the displayed or discussed mutual couplings or direct couplings or communication connections may be implemented by using some interfaces. The indirect couplings or communication connections between the apparatuses or units may be implemented in electronic, mechanical, or other forms.

The foregoing units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An information transmission method, comprising:
receiving first indication information from a network device, wherein the first indication information indicates a first access threshold corresponding to a first synchronization signal; and
determining, based on a value relationship between a local access value and the first access threshold, whether to send random access request information on a random access channel occasion corresponding to the first synchronization signal.

2. The method according to claim 1, wherein receiving the first indication information from the network device comprises:
receiving first information from the network device, wherein the first information is used to configure the random access channel occasion corresponding to the first synchronization signal, and the first information comprises the first indication information.

3. The method according to claim 2, wherein the local access value is a value randomly selected in sample space.

4. The method according to claim 1, wherein determining, based on the value relationship between the local access value and the first access threshold, whether to send the random access request information to the network device on the random access channel occasion corresponding to the first synchronization signal comprises:
if the local access value is greater than or equal to the first access threshold, determining to send the random access request information on the random access channel occasion corresponding to the first synchronization signal; or
if the local access value is less than or equal to the first access threshold, determining to send the random access request information on the random access channel occasion corresponding to the first synchronization signal.

5. The method according to claim 4, wherein the method further comprises:
sending the random access request information to the network device on the random access channel occasion corresponding to the first synchronization signal.

6. The method according to claim 1, wherein determining, based on the value relationship between the local access value and the first access threshold, whether to send the random access request information to the network device on the random access channel occasion corresponding to the first synchronization signal comprises:
if the local access value is less than the first access threshold, determining not to send the random access request information to the network device on the random access channel occasion corresponding to the first synchronization signal; or
if the local access value is greater than the first access threshold, determining not to send the random access request information to the network device on the random access channel occasion corresponding to the first synchronization signal.

7. The method according to claim 6, wherein the method further comprises:
receiving second indication information from the network device, wherein the second indication information indicates a second access threshold corresponding to a second synchronization signal, and the second access threshold is used by a terminal to determine whether to perform a random access procedure, wherein
the second synchronization signal and the first synchronization signal are different synchronization signals in a synchronization signal set in a same synchronization signal periodicity, or the second synchronization signal and the first synchronization signal are synchronization signals in different synchronization signal periodicities.

8. An information transmission method, comprising:
determining first indication information, wherein the first indication information indicates a first access threshold corresponding to a first synchronization signal, and the first access threshold is used by a terminal to determine whether to perform a random access procedure; and
sending the first indication information.

9. The method according to claim 8, wherein sending the first indication information comprises:
sending first information, wherein the first information is configuration information of a random access channel occasion corresponding to the first synchronization signal, and the first information comprises the first indication information.

10. The method according to claim 8, wherein the method further comprises:
determining the first access threshold based on a quantity of terminals within a coverage range of the first synchronization signal and a quantity of random access channel occasions corresponding to the first synchronization signal.

11. The method according to claim 10, wherein the method further comprises:
obtaining the quantity of terminals through inference based on sensing data and/or historical data, wherein
the sensing data comprises a quantity of terminals within the coverage range of the first synchronization signal that is obtained through sensing signal detection, and the historical data comprises a historical quantity of terminals within the coverage range of the first synchronization signal.

12. A communication apparatus, comprising:
a transceiver unit, configured to receive first indication information from a network device, wherein the first indication information indicates a first access threshold corresponding to a first synchronization signal; and
a processing unit, configured to determine, based on a value relationship between a local access value and the first access threshold, whether to send random access request information on a random access channel occasion corresponding to the first synchronization signal.

13. The apparatus according to claim 12, wherein
the transceiver unit is specifically configured to receive first information from the network device, wherein the first information is used to configure the random access channel occasion corresponding to the first synchronization signal, and the first information comprises the first indication information.

14. The apparatus according to claim 13, wherein the local access value is a value randomly selected in sample space.

15. The apparatus according to claim 12, wherein the processing unit is specifically configured to:
if the local access value is greater than or equal to the first access threshold, determine to send the random access request information on the random access channel occasion corresponding to the first synchronization signal; or
if the local access value is less than or equal to the first access threshold, determine to send the random access request information on the random access channel occasion corresponding to the first synchronization signal.

16. The apparatus according to claim 15, wherein the transceiver unit is further configured to:
send the random access request information to the network device on the random access channel occasion corresponding to the first synchronization signal.

17. The apparatus according to claim 12, wherein the processing unit is specifically configured to:
if the local access value is less than the first access threshold, determine not to send the random access request information to the network device on the random access channel occasion corresponding to the first synchronization signal; or
if the local access value is greater than the first access threshold, determine not to send the random access request information to the network device on the random access channel occasion corresponding to the first synchronization signal.

18. The apparatus according to claim 17, wherein the transceiver unit is further configured to:
receive second indication information from the network device, wherein the second indication information indicates a second access threshold corresponding to a second synchronization signal, and the second access threshold is used by a terminal to determine whether to perform a random access procedure, wherein
the second synchronization signal and the first synchronization signal are different synchronization signals in a synchronization signal set in a same synchronization signal periodicity, or the second synchronization signal and the first synchronization signal are synchronization signals in different synchronization signal periodicities.
